(19) United States
(12) Patent Application Publication
(10) Pub. No.: US 2018/0240164 A1
(43) Pub. Date: Aug. 23, 2018

(54) COST PER MILE CALCULATION SYSTEM

(71) Applicant: OMNITRACS, LLC, Dallas, TX (US)

(72) Inventor: John Donald MIDTBO, Coppell, TX (US)

(21) Appl. No.: 15/436,238

(22) Filed: Feb. 17, 2017

(51) Int. Cl. G06Q 30/04

(52) U.S. Cl. CPC G06Q 30/04

(57) ABSTRACT

The described features of the present disclosure generally relate to one or more improved systems for estimating driving costs for an operator of a vehicle. Accordingly, features of the present disclosure may include receiving, at a communication device, a plurality of information corresponding to at least an operator and a vehicle of the operator, executing, at the communication device, one or more analytics functions to determine a cost-per-mile (CPM) metric based at least on the plurality of information corresponding to at least the operator and the vehicle of the operator, and providing a CPM report including the CPM metric to the operator based on executing the one or more analytics functions.

### BACKGROUND

Aspects of the present disclosure generally relate to fleet management systems, and more particularly to estimating driving costs for determining estimated profits of potential delivery routes.

Nearly every good consumed by households and businesses, at some point, is transported on a truck. The vast majority of communities rely on trucks to routinely deliver all of their essential products necessary for basic existence. The trucking industry includes fleet operators, who manage fleets of tens or hundreds of trucks, and owner operators, who manage one or a small number of trucks. These owner operators may not necessarily have access to the complex tools large fleet operators do. Therefore, it is increasingly difficult for owner operators to calculate their cost for operating a vehicle, and in turn, determining whether a potential delivery route is profitable.

As such, improvements in estimating driving costs for an operator and the vehicle of the operator are desired.

### SUMMARY

The following presents a simplified summary of one or more aspects of the present disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the present disclosure in a simplified form as a prelude to the more detailed description that is presented later.

In accordance with some aspects, this disclosure includes a method relating to estimating driving costs. The method includes receiving, at a communication device, a plurality of information corresponding to at least an operator and a vehicle of the operator. The method further includes executing, at the communication device, one or more analytics functions to determine a cost-per-mile (CPM) metric based at least on the plurality of information corresponding to at least the operator and the vehicle of the operator. The method additionally includes providing a CPM report including the CPM metric to the operator based on executing the one or more analytics functions.

In accordance with some aspects, this disclosure includes an apparatus for estimating driving costs. The apparatus includes a processor, a memory coupled to the processor, wherein the memory includes instructions executable by the processor to receive, at a communication device, a plurality of information corresponding to at least an operator and a vehicle of the operator. The apparatus is further configured to execute, at the communication device, one or more analytics functions to determine a CPM metric including the CPM metric based at least on the plurality of information corresponding to at least the operator and the vehicle of the operator. The apparatus also is configured to provide a CPM report to the operator based on executing the one or more analytics functions.

In accordance with some aspects, this disclosure includes a non-transitory computer readable medium for estimating driving costs. The computer readable medium includes code executable by a processor to receive, at a communication device, a plurality of information corresponding to at least an operator and a vehicle of the operator. The computer readable medium includes code executable by a processor to execute, at the communication device, one or more analytics functions to determine a cost-per-mile (CPM) metric based at least on the plurality of information corresponding to at least the operator and the vehicle of the operator. The computer readable medium includes code executable by a processor to provide a CPM report to the operator based on executing the one or more analytics functions to determine the CPM metric.

To the accomplishment of the foregoing and related ends, the one or more aspects of the present disclosure comprise the features hereinafter fully described and particularly pointed out in the claims. The following description and the annexed drawings set forth in detail certain illustrative features of the one or more aspects of the present disclosure. These features are indicative, however, of but a few of the various ways in which the principles of various aspects of the present disclosure may be employed, and this description is intended to include all such aspects and their equivalents.

### BRIEF DESCRIPTION OF THE DRAWINGS

The disclosed aspects of the present disclosure will hereinafter be described in conjunction with the appended drawings, provided to illustrate and not to limit the disclosed aspects, wherein like designations denote like elements, where a dashed line may indicate an optional element or action, and in which:

FIG. 1 is a schematic block diagram of elements of an example system including an analytics functions component for estimating driving costs;

FIG. 2 is a flowchart of an aspect of a method of estimating driving costs in accordance with the present disclosure; and

FIG. 3 is a block diagram of an example of an electronic logging device (ELD) and/or a communication device in accordance with the present disclosure.

### DETAILED DESCRIPTION

Various aspects of the systems, apparatuses, and methods are described more fully hereinafter with reference to the accompanying figures. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the systems, apparatuses, and methods disclosed herein, whether implemented independently of, or combined with, any other aspect described herein. For example, an apparatus may be implemented or a method may be practiced using any number of the aspects set forth herein. In addition, the scope of the present aspects is intended to cover such an apparatus or method which is practiced using other structure, functionality, or structure and functionality in addition to or other than the various aspects set forth herein. It should be understood that any aspect disclosed herein may be embodied by one or more elements of a claim.

Although particular aspects are described herein, many variations and permutations of these aspects fall within the scope of the disclosure. Although some benefits and advantages of the aspects are mentioned, the scope of the disclosure is not intended to be limited to particular benefits, uses, or objectives. Rather, aspects of the disclosure are intended to be broadly applicable to different communication technologies, system configurations, networks, and transmission protocols, some of which are illustrated by way of example in the figures and in the following description of the aspects. The detailed description and figures are merely illustrative of the disclosure rather than limiting, the scope of the disclosure being defined by the appended claims and equivalents thereof.

The present aspects generally relate to estimating driving costs. Specifically, in some fleet management systems, a fleet vehicle driver may operate the vehicle as an owner operator. As the fleet vehicle driver performs the assignments or tasks, the fleet vehicle may be readily tracked (e.g., via GPS and/or onboard sensors). However, these owner operators may not necessarily have access to the complex tools large fleet operators do with regard to the business aspects of operating the vehicle. Therefore, it is increasingly difficult for owner operators to calculate their cost for operating the vehicle, and in turn, determining whether a potential delivery route or load is profitable.

Accordingly, the present aspects provide one or more solutions to estimate driving costs for the operator of the vehicle. The present aspects allow for receiving, at a communication device, a plurality of information corresponding to at least an operator and a vehicle of the operator. In some aspects, the communication device may execute one or more analytics functions to determine a cost-per-mile (CPM) metric based at least on the plurality of information corresponding to at least the operator and the vehicle of the operator. Additionally, the communication device may provide a CPM report to the operator based on executing the one or more analytics functions.

For example, the present aspects may be implemented in an application on an electronic logging device (ELD) of an independent owner operator in order to provide them with the costs to operate their truck. The application may include CPM metrics based on analytics functions applied to real time data from the ELD and/or other data sources. The owner operator could use this information to gain confidence that they can make a profit on any route and load. This would allow the owner operator to intelligently accept or decline a particular load and give them leverage at negotiating rates.

Various aspects will now be described with reference to the drawings. In the following description, for purposes of explanation, numerous specific details are set forth in order to provide a thorough understanding of one or more aspects. It should be understood, however, that such aspect(s) may be practiced without these specific details.

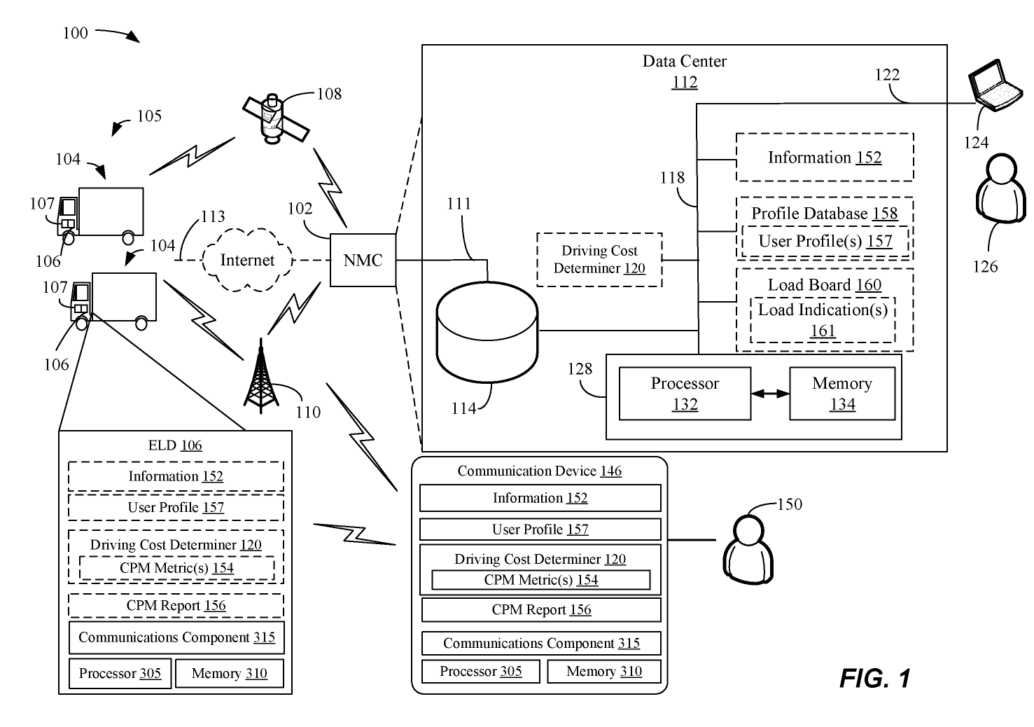

Referring to FIG. 1, in an aspect, a system 100 includes components for estimating driving costs for an operator 150 associated with one or more vehicles 104. As used herein, the terms “component(s)” may be one of the parts that make up a device, may be hardware or software or firmware, and may be divided into other modules and/or distributed across one or more processors.

In an aspect, system 100 can comprise a network management center (NMC) 102 configured to communicate with one or more vehicles 104 via a ELD 106 located on each vehicle 104 or associated with each driver (e.g., an owner operator) of each vehicle 104. The system 100 may include one or more fleets of vehicles 104, each fleet having at least one vehicle. An example fleet 105 is illustrated as having two vehicles 104, although the present disclosure can apply to a single vehicle 104 driven by a single owner operator. In implementations, each ELD 106 is configured to collect and transmit data associated with the driver and/or the operation of the vehicle 104 to the NMC 102. Also, in some implementations, ELD 106 can be configured to perform calculations associated with one or more driving cost and/or fleet and/or driver management or performance component(s) using any of the collected data. In an aspect, the driving cost and/or fleet and/or driver management or performance component(s) may be implemented as a software application defined by code or instructions stored in a computer-readable medium and executed by a processor, and/or as hardware (e.g., a specially programmed processor module), and/or as firmware. According to the present aspects, one of the driving cost and/or fleet and/or driver management or performance component(s) may include driving cost determiner component 120, which is configured to collect vehicle-related and/or operator-related information 152 and generate one or more CPM metrics 154, such as in a CPM report 156, in order to enable each driver or operator 150 (e.g., an owner operator) of each vehicle 104 to understand the costs associated with operating the vehicle 104 and/or with accepting a potential load, as will be discussed in more detail below.

In some implementations, ELD 106 may include a processor configured to execute one or more driving cost and/or fleet and/or driver management or performance components, one or more transceivers to perform associated communications with external devices such as NMC 102 via a communication network, and a memory configured to store computer-readable code that may define all or part of the components and also to store data associated with the components and/or ELD 106. ELD 106 may also include a user interface or display, a mobile application server, and a communications component (e.g., including the one or more transceivers, and one or more of terrestrial and Wi-Fi modems, one or more antennae, a GPS component, and a satellite communications component). For example, in an aspect, ELD 106 may include, but is not limited to, the Intelligent Vehicle Gateway (IVG) platform sold by OMNITRACS LLC of Dallas, Tex., which may include driving cost and/or fleet and/or driver management or performance components. For instance, the fleet and/or driver management or performance components may include, but not limited to, a driver log component (also referred to as an Hours of Service component), an Analytics Manager component, a Critical Event Reporting component, a Driver Workflow component, an Extended Productivity Suite component, a Fault Monitoring component, an In-Cab Navigation component, an In-Cab Scanning component, an In-Cab Video Training component, a Media Manager component, a Performance Monitoring component with a Fuel Manager component, a Predictive Performance Service component, a Trip Manager component, a Vehicle Maintenance and Inspection Reporting component, and a Web Browsing component.

As an example, and not to be construed as limiting, each vehicle 104 may be in bi-directional communication with NMC 102 over at least one communication channel. In the example shown in FIG. 1, each vehicle 104 is in bi-directional communication with the NMC 102 over at least one of a satellite-based communication system 108 and a terrestrial-based system 110 (e.g., a wireless communication system using a communication protocol/technology such as, but not limited to, GSM, CDMA, TDMA, WCDMA, EDGE, OFDM, GPRS, EV-DO, LTE, 4G, 5G, WiFi, Bluetooth, or, when the vehicle is stopped, via a wired connection 113 through the Internet). Depending on many factors, data may be exchanged with the vehicles 104 using one or both of the satellite communication system 108 and the terrestrial-based communication system 110.

In an aspect, many different types of data are collected and transferred from the vehicles 104 to the NMC 102 The data may relate to one or more CPM metrics 154. For instance, such data may include a plurality of information 152 corresponding to at least an operator 150 and a vehicle 104 of the operator 150. For example, the plurality of information 152 may include, but is not limited to, one or any combination of fuel costs, miles driven by the vehicle 104, insurance costs of the vehicle 104, maintenance costs of vehicle 104 (e.g., service costs, tire replacement, etc.), vehicle costs (e.g., down payment and/or loan payments; rental payments; etc.), brokerage fees, permits, toll fees, and workers compensation of the operator 150. Other examples of such data include, but are not limited to, driver performance data, driver duty status such as driver log information, truck performance data, critical events, messaging and position data, location delivery data, and many other types of data. The data associated with the operation of the vehicle 104 may further include driver log information collected by the driver log component. In some examples, the driver log component may employ the user interface or display of the ELD 106 to allow a truck driver, for example, to enter relevant driver log information 121 (e.g., on-duty and driving, on-duty but not driving, off-duty, resting/sleeping, etc.) for one or more sampled time points into the ELD 106.

All of the information, including the CPM metric 152, that is communicated to and from the vehicles 104 is processed via the NMC 102. The NMC 102 can be thought of as a data clearinghouse that receives all data that is transmitted to and received from the vehicles 104. Moreover, in an aspect, NMC 102 may include one or more back-end servers for distributing the software update to one or more ELD(s) 106. Thus, in some aspects, the collected information may periodically (e.g., every x minutes, where x is a whole number, or once a day, or upon availability of a wired or wireless connection) be transmitted from the ELD 106 to the NMC 102 for analysis and record keeping.

The system 100 also includes a data center 112, which may be part of or in communication with NMC 102. The data center 112 illustrates one possible implementation of a central repository for all of the data received from each of the vehicles 104. As an example, as mentioned above, many different types of data are transmitted from the vehicles 104 to the NMC 102. In the case where data center 112 is in communication with NMC 102, the data may be transmitted via connection 111 to the data center 112. The connection 111 may comprise any wired or wireless dedicated connection, a broadband connection, or any other communication channel configured to transport the data. Moreover, in an aspect, data center 112 may include one or more back-end servers for distributing the software update to one or more ELD(s) 106.

In an aspect, the data center 112 may include a data warehouse 114 for receiving the data from vehicles 104 relating to fleet and/or driver management or performance. In an aspect, for example, data center 112 may include any number of application servers and data stores, where each may be associated with a separate fleet and/or driver management or performance data. In an aspect, each application server and data store may include a processor, memory including volatile and non-volatile memory, specially-programmed operational software, a communication bus, an input/output mechanism, and other operational systems. For example, an application server may include one or more servers having one or more driving cost models use by driver cost determiner component 120 in determining one or more CPM metrics 154, such as based on receiving the plurality of information 152 from ELD(s) 106. Further, for example, an application server may be a services portal (SP) server that receives, for example, messaging and positioning (M/P) data and/or location delivery efficiency (LDE) data from each of the vehicles 104. Another application server, for example only, may include one or more servers related to safety and compliance, such as a quick deployment center (QDC) server that receives, for example, critical event (CE) data from each of the vehicles 104. Further, for example, another application server may be a fuel cost server that receives, for example, vehicle and driver performance data related to fuel usage and/or cost from each of the vehicles 104. Additionally, for example only, another application server may relate to asset management, such as a Vehicle Maintenance and Vehicle Inspection Report server that receives, for example, maintenance and/or inspection data from each of the vehicles 104. It should be understood that the above list of example servers is for illustrative purposes only, and data center 112 may include additional and/or different application servers.

In an aspect, communication system 100 may include one or more devices, such as communication device 146 (e.g., a smartphone, tablet computer, etc.), which may operate cooperatively with ELD 106 or which may be an alternative to ELD 106. Communication device 146 may also include driver cost determiner component 120, along with a communication component 415, one or more processors 405, and/or a memory 410. In some aspects, communication device 146 may be an extended productivity device, such as a cell phone or tablet type device, which may be carried by the driver or operator 150 and which communicates with and may be used in conjunction with ELD 106 located in or part of the vehicle 104. In some aspects, some or all of the functionalities of ELD 106 and communication device 1456 may be maintained or integrated within a single device, for example, one of ELD 106 or communication device 146.

According to the present disclosure, driving cost determiner component 120, which may be located in ELD 106 or communication device 146, may be configured to receive the plurality of information 152 corresponding to at least operator 150 and/or vehicle 104 of the operator 150 in order to determine driving costs and/or to estimate a cost of hauling a potential load, thereby enable operator 150 to make decisions with respect to operating vehicle 104. For example, the plurality of information includes at least one of fuel costs, miles driven by the vehicle 104, insurance costs of the vehicle 104, maintenance costs of vehicle 104, tire costs of the vehicle 104, vehicle costs, brokerage fees, permits, potential toll fees, and workers compensation of the operator 150. Further, in an example, a portion of the plurality of information 152 may be received from a vehicle parameter monitoring device 107, such as a controller area network (CAN bus) device, located within the vehicle 104. For example, vehicle parameter monitoring device 107 may monitor and/or obtain some of the plurality of information 152 from one or more electronic control units (ECUs) and/or sensors on vehicle 104. For instance, example ECUs include, but not limited to, control units for engine control, transmission, airbags, antilock braking/ABS, cruise control, electric power steering, audio systems, power windows, doors, mirror adjustment, battery and recharging systems for hybrid/electric cars, etc. Also, for instance, example sensors include or can measure, but are not limited to, vehicle speed, steering angle, air conditioning state, engine temperature, brake state, traction control state, parking sensors, mirror control, lane assist/collision avoidance, automatic braking, windshield wipers, rain sensors, gas level, miles per gallon, tire pressure, weight of load, etc. Additionally, in an example, a portion of the plurality of information 152 may be obtained from a network operations system (e.g., NMC 102) remote from ELD 106 or communication device 146. Moreover, when driving cost determiner component 120 is operating on one of ELD 106 or communication device 146, at least a portion of the plurality of information 152 is received from the other device (e.g., the other one of ELD 106 or communication device 146), vehicle parameter monitoring device 107, and a network operations system (e.g., NMC 102).

In some aspects, ELD 106 or communication device 146 executing driving cost determiner component 120 may create a user profile 157 for the operator 150 having a plurality of user data, the user profile 157 also including at least a portion of the plurality of information 152. In some examples, operator 150 may manually enter some of the user data including at least identification information of the operator 150, salary of the operator 150, cost of the vehicle 104, insurance for the vehicle 104, maintenance cost of the vehicle 104, cost of fuel, etc. In other examples, the user profile 157 may be automatically generated based on receiving at least a portion of the plurality of information 152 from external sources, such as, ELD 106 or communication device 146 (e.g., whichever one is not executing driving cost determiner component 120) and/or NMC 102.

In an aspect, driving cost determiner component 120 may execute one or more analytics functions to determine one or more CPM metrics 154 based at least on the plurality of information 152 corresponding to at least the operator 150 and the vehicle 104 of the operator 150. For example, the one or more CPM metrics 154 may include, but are not limited to, a CPM over a length of a route for a given load, a CPM over a length of time (e.g., including one or more loads), a CPM comparison with one or more other operators, or a CPM for individual vehicle cost items (e.g., vehicle insurance, driver/operator insurance, vehicle loan, maintenance, fuel, driver/operator salary, etc. Further, in an example, driving cost determiner component 120 may execute the one or more analytics functions to determine the one or more CPM metrics 154 periodically.

In some examples, communication device 146 may be configured to associate the one or more CPM metrics 154 with the user profile 157. In some instances, driving cost determiner component 120 executes one or more analytics functions to determine a new CPM metric for the potential load based on the user profile 157 and the information corresponding to the potential load. Moreover, the user profile 157 of operator 150 may be updated periodically, such as, whenever driving cost determiner component 120 executes one or more analytics functions to determine a new CPM metric, so that the new CPM metric is associated with the user profile 157. ELD 106 or communication device 146 may transmit the user profile 157 including the associated CPM metric 154 to a network operations system (e.g., NMC 102) remote from the ELD 106 or communication device 146. The user profile 157 may be stored in a profile database 158 of the network operations system with a plurality of user profiles corresponding to a plurality of different operators.

In an aspect, communication device 146 and/or driving cost determiner component 120 may provide a CPM report 156 to the operator 150 based on executing the one or more analytics functions to determine the one or more CPM metrics 154. For example, the CPM report 156 may include, but is not limited to including, one or more CPM metrics 154 and/or other operator-related and/or vehicle-related information, such as total miles driven by the operator 150 over a time period, total miles driven by the operator 150 compared to total miles driven by a plurality of operators, a miles per gallon (MPG) comparison with the plurality of operators, performance data analytics, and service recommendations.

Besides generally providing operator 150 with the one or more CPM metrics 154 for assessing operating costs of vehicle 104, driving cost determiner component 120 may be additionally configured to enable operator 150 to assess the profitability of accepting a new load or job. For example, ELD 106 or communication device 146 executing driving cost determiner component 120 may receive a load indication 161 including information corresponding to a potential load (e.g., estimated size and weight, description of the goods, etc.) with a pickup location and a delivery destination for a potential client. ELD 106 or communication device 146 may receive or may access the load indication 161, for example, from a load board 160 accessible via a wired or wireless network. In one example, a network operations system (e.g., NMC 102) may maintain load board 160, having one or more potential loads to be delivered, remote from ELD 106 or communication device 146. It should be noted that besides being accessible by ELD 106 or communication device 146, data center 112 may enable access to the profile database 158 and load board 160 over connection 122 with a terminal device 124. As such, terminal device 124 may be operated by a user 126, which may be operator 150 or fleet manager, or a client populating load board 160, to input or output the associated data in a usable format. The terminal device 124 can be a user interface portal, a web-based interface, a personal computer (PC), a laptop, a personal data assistant (PDA), a dedicated terminal, a dumb terminal, or any other device over which user 126 can view the display or receive a printed report provided by profile database 158 and load board 160. In any case, in an example, driving cost determiner component 120 may be configured to execute the one or more analytics functions to determine one or more CPM metrics 154 in response to receiving the load indication 161, where the one or more CPM metrics 154 in this case relate to costs and/or profitability associated with operating vehicle when accepting the potential load for delivery.

In one example use case, driving cost determiner component 120 may be configured to execute one or more additional analytics functions to determine an estimated profit margin for delivering the potential load based at least on the one or more CPM metrics 154 and the information associated with load indication 161. For example, driving cost determiner component 120 may determine a route distance for delivery of the potential load based at least on an initial starting location of the vehicle 104, and/or a pickup location of the load, and the delivery destination location. Driving cost determiner component 120 may also determine an average fuel cost between the initial starting or pickup location and the delivery destination location. Driving cost determiner component 120 may then calculate a load specific CPM metric based at least on at least on the plurality of information 152 and the average fuel cost. Further, driving cost determiner component 120 may calculate a total route cost for the potential delivery route based at least on the route distance and the load specific CPM metric.

In some examples, the load indication 161 may include a price quote, e.g., the amount of compensation (e.g., money) operator 150 will receive for delivering the potential load. As such, driving cost determiner component 120 may determine the estimated profit margin for the potential load by calculating the difference between the price quote and the total route cost. In some instances, as noted above, driving cost determiner component 120 may execute one or more additional analytics functions to determine an estimated profit margin for the potential load based at least on the CPM metric 154 and the load indication 161. In other instances, driving cost determiner component 120 may execute one or more additional analytics functions to determine an estimated profit margin for the potential load by calculating the estimated profit margin for the potential delivery load based at least on load specific CPM metric and the price quote.

Further, in some aspects, ELD 106 or communication device 146 may receive a user selection from the operator 150 to trigger providing the CPM report 156 to the operator 150. In an example, the user selection may be a manual input by the operator 150 corresponding to initiating a request to generate a respective CPM report 156, or to initiate an assessment of whether or not it would be profitable to accept a potential load for delivery based on a respective load indication 161. In the use case of evaluating load indication 161, after generating the profitability assessment (e.g., in CPM report 156), ELD 106 or communication device 146 may then receive a user selection corresponding to an acceptance or rejection of the potential load (referred to as a user response). ELD 106 or communication device 146 may then transmit the user response to a network operations system (e.g., NMC 102) based on a determination whether the user selection corresponds to the acceptance or rejection of the potential load. For example, ELD 106 or communication device 146 may determine that the user selection corresponds to the acceptance of the potential load, and may receive an assignment of the potential load to at least the operator 150 or the vehicle 104 of the operator 150 based on transmitting the user response to the network operations system. In another example, ELD 106 or communication device 146 may determine that the user selection does not correspond to the acceptance of the potential load, e.g., a rejection, and may receive a second load indication 161 for delivery a second load based on transmitting the user response to the network operations. The second load indication 161 may include information corresponding to the second load (e.g., size, weight, description of goods), a second pickup location and delivery destination location, a potential delivery route, etc., for at least the client or a second client. It should be noted that the example implementation illustrated in FIG. 1 should not be construed as limiting, as one of skill in the art may modify this implementation and achieve similar results. For instance, rather than the illustrated components and described functionality of driving cost determiner component 120 for estimating driving costs operating remotely from ELD 106 or communication device 146, driving cost determiner component 120 may instead be located at and executed by NMC 102 and/or data center 112. In this case, NMC 102 and/or data center 112 may then output CPM report(s) 156 and transmit them, e.g., to the driver or operator 150 of vehicle 104 and/or to user 126 (e.g., operator of fleet 105 of vehicles 104) or a manager of system 100, such as a company like OMNITRACS, LLC of Dallas, Tex.

Further, it should be noted that NMC 102 and/or data center 112 may operate via a processing system 128, for example, connected via a system bus 130. In an aspect, the processing system 128 includes a processor 132 and a memory 134. In an example implementation, the functionality of profile database 158, load board 160, and/or driver cost determiner component 120 as described herein may be implemented in one or more hardware or firmware processor components of processor 132. For instance, although illustrated as being separate components, profile database 158, load board 160, and/or driver cost determiner component 120 may be a part of or in communication with processor 132. In another example implementation, the memory 134 can store the routines or functionality, e.g., in the form of computer-readable code or instructions, and/or the corresponding data, that are associated with operating profile database 158, load board 160, and/or driver cost determiner component 120. In an aspect, the processor 132 can execute the stored routines (e.g., code) to implement the functionality of profile database 158, load board 160, and/or driver cost determiner component 120 that are described herein. Although shown as residing within the data center 112, the processing system 128 may reside elsewhere, and may be implemented as a distributed system in which the processor 132 and the memory 134 may include one or more processor and memories, and may be located in different places, such as at NMC 102 and/or one or more servers associated with NMC 102 or data center 112.

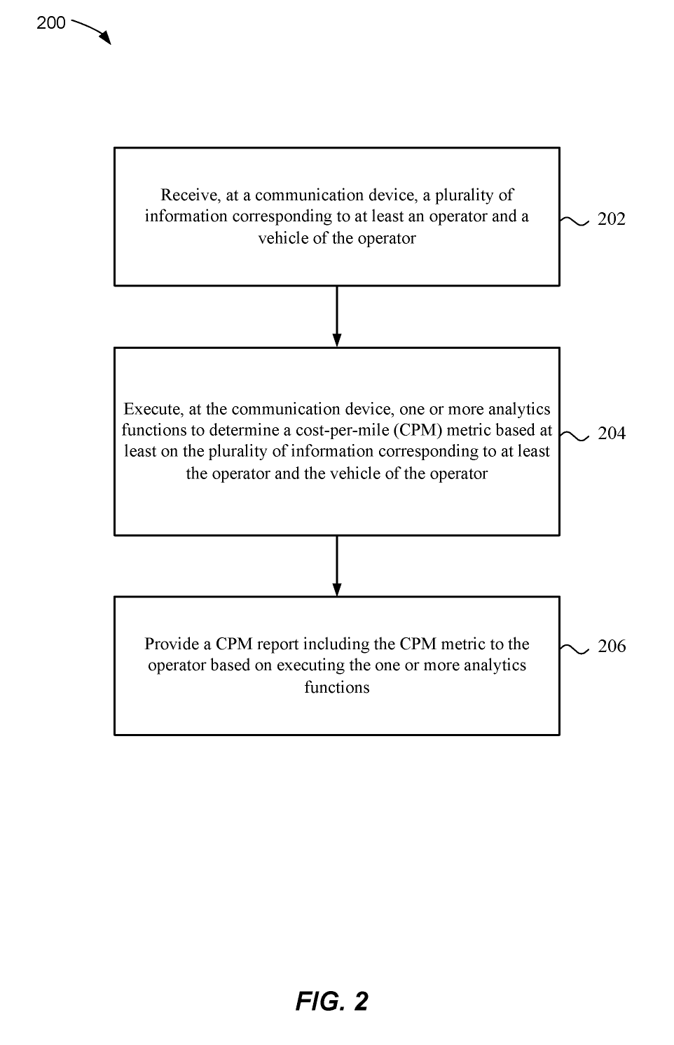

Referring to FIG. 2, an example of one or more operations of an aspect of driving cost determiner component 120 (FIG. 1) according to the present apparatus and methods are described with reference to one or more methods and one or more components that may perform the actions of these methods. Although the operations described below are presented in a particular order and/or as being performed by an example component, it should be understood that the ordering of the actions and the components performing the actions may be varied, depending on the implementation. Also, it should be understood that driving cost determiner component 120 may have a number of subcomponents, and that one or more of the illustrated subcomponent may be separate from, but in communication with, the driving cost determiner component 120 and/or each other. Moreover, it should be understood that the following actions or components described with respect to the driving cost determiner component 120 and/or its subcomponents may be performed by a specially-programmed processor, a processor executing specially-programmed software or computer-readable media, or by any other combination of a hardware component and/or a software component specially configured for performing the described actions or components. In some aspects, method 200 may be performed at ELD 106 (FIG. 1), or communication device 146, or at NMC 102 or data center 112, or at some combination thereof. Also, some operations in method 200 may be combined, the order of some operations may be changed, and some operations may be omitted.

In an aspect, at block 202, method 200 includes receiving, at a communication device, a plurality of information corresponding to at least an operator and a vehicle of the operator. For example, ELD 106 (FIG. 1) or communication device 146 (FIG. 1) may execute one or more components and/or components (e.g., driving cost determiner component 120, FIG. 1) to receive a plurality of information 152 corresponding to at least operator 150 and vehicle 104 of the operator 150. The plurality of information 152 may include, but is not limited to, one or more of fuel costs, miles driven by the vehicle 104, insurance costs of the vehicle 104, maintenance costs of vehicle 104 (e.g., service costs, tire replacement, etc.), vehicle costs (e.g., down payment and/or loan payments; rental payments; etc.), brokerage fees, permits, toll fees, and workers compensation of the operator 150.

In aspect, at block 204, method 200 includes executing, at the communication device, one or more analytics functions to determine a CPM metric based at least on the plurality of information corresponding to at least the operator and the vehicle of the operator. For example, ELD 106 (FIG. 1) or communication device 146 (FIG. 1) may execute one or more components and/or components (e.g., driving cost determiner component 120, FIG. 1) to execute one or more analytics functions to determine CPM metric 154 based at least on the plurality of information 152 corresponding to at least the operator 150 and the vehicle 104 of the operator 150.

In one case, CPM metric 154 may be a simple cost per mile determination over a period of time, e.g., based on a historical set of the plurality of information 152.

For example, in this case, the one or more analytics functions may relate to one or more driving cost models for determining one or more respect CPM metrics 154. An example analytics function may determine a general CPM metric 154 as follows:

CPM metric=(Fuel Card Data+Driver Compensation+Insurance Cost+Maintenance Costs+Tire Costs+Truck & Trailer Payment+Bill for Onboard Technology+Brokerage Fees+Permits+Tolls+Workers Comp)/Miles Driven,
where:
the Fuel Card Data includes at least the Miles Per Gallon (MPG) of the vehicle 104, the Driver Compensation includes the pay of operator 150, the Insurance Cost includes the insurance premium of vehicle 104, the Maintenance Costs include the amount paid for repairs on vehicle 104, Tire Costs include the cost of the tires of vehicle 104, the Truck & Trailer Payment includes the cost of vehicle 104, the Bill for Onboard Technology includes the costs for using Omnitracs® and other systems, the Brokerage Fees include the cost for accepting the potential load, the Permits include the costs for obtaining permits to operate the vehicle 104, the Tolls include the costs for the tolls on the route for the potential load, and Workers Comp includes the costs for receiving workers compensation.

In another case, CPM metric 154 may be a prospective cost per mile assessment, for instance, based on a combination of the historical set of the plurality of information 152 and information relating to a potential load associated with load indication 161.

For example, in this case, the one or more analytics functions may relate to one or more driving cost models for determining one or more respect CPM metrics 154. An example analytics function may determine a load-specific CPM metric 154 as follows:

CPM metric=(Fuel Card Data_{H}+Driver Compensation_{H}+Insurance Cost_{H}+Maintenance Costs_{H}+Tire Costs_{H}+Truck & Trailer Payment_{H}+Bill for Onboard Technology_{H}+Brokerage Fees_{H}+Permits_{H}+Tolls_{H}+Workers Comp_{H})/Miles Driven_{H},
where:
the Fuel Card Data_{H} includes at least the historical Miles Per Gallon (MPG) of the vehicle 104, the Driver Compensation_{H} includes the historical pay of operator 150, the Insurance Cost_{H} includes the historical insurance premium of vehicle 104, the Maintenance Costs_{H} include the historical amount paid for repairs on vehicle 104, Tire Costs_{H} include the historical cost of the tires of vehicle 104, the Truck & Trailer Payment_{H} includes historical the cost of vehicle 104, the Bill for Onboard Technology_{H} includes the historical costs for using Omnitracs® and other systems, the Brokerage Fees_{H} include the historical cost for accepting the potential load, the Permits_{H} include the historical costs for obtaining permits to operate the vehicle 104, the Tolls_{H} include the costs for the tolls on the route for the potential load, and Workers Comp_{H} includes the historical costs for receiving workers compensation

In aspect, at block 206, method 200 includes providing a CPM report including the CPM metric to the operator based on executing the one or more analytics functions. For example, ELD 106 (FIG. 1) or communication device 146 (FIG. 1) may execute one or more components and/or components (e.g., driving cost determiner component 120, FIG. 1) to provide a CPM report 156 including the CPM metric 154 to the operator 150 based on executing the one or more analytics functions. As such, method 200 may provide operator 150 with CPM metric 154 that identifies a cost of operating vehicle 104, such as an average cost over a period of time, or such as an assessment of a load-specific cost associated with a potential load to be delivered.

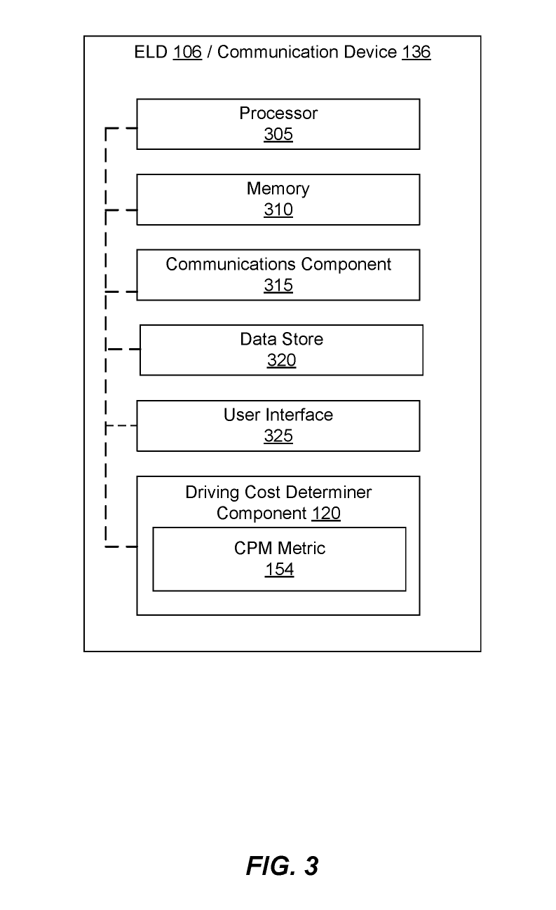

Referring to FIG. 3, in an example that should not be construed as limiting, ELD 106 and/or communication device 146 may include components (some of which have been described above, some of which are additional components described in more detail here) that operate in conjunction with driving cost determiner component 120, which may be implemented in specially programmed computer readable instructions or code, firmware, hardware, or some combination thereof.

In an aspect, for example as represented by the dashed lines, features described herein with respect to the functions of driving cost determiner component 120 may be implemented in or executed using one or any combination of processor 305, memory 310, communications component 315, and data store 320. For example, driving cost determiner component 120 may be defined or otherwise programmed as one or more processor components of processor 305. Further, for example, driving cost determiner component 120 may be defined as a computer-readable medium (e.g., a non-transitory computer-readable medium) stored in memory 310 and/or data store 320 and executed by processor 305. Moreover, for example, inputs and outputs relating to operations of driving cost determiner component 120 may be provided or supported by communications component 315, which may provide a bus between the components of the device or an interface for communication with external devices or components.

Processor 305 can include a single or multiple set of processors or multi-core processors. Moreover, processor 305 can be implemented as an integrated processing system and/or a distributed processing system.

Memory 310 may operate to allow storing and retrieval of data used herein and/or local versions of applications and/or software and/or instructions or code being executed by processor 305, such as to perform the respective functions of driving cost determiner component 120 described herein. Memory 310 can include any type of memory usable by a computer, such as random access memory (RAM), read only memory (ROM), tapes, magnetic discs, optical discs, volatile memory, non-volatile memory, and any combination thereof.

Communications component 315 is operable to establish and maintain communications with one or more internal components/components or external devices utilizing hardware, software, and services as described herein. Communications component 315 may carry communications between components on ELD 106 and/or communication device 146, as well as between user and external devices, such as devices located across a communications network and/or devices serially or locally connected to ELD 106 and/or communication device 146. For example, communications component 315 may include one or more buses, and may further include transmit chain components and receive chain components associated with a transmitter and receiver, respectively, or a transceiver, operable for interfacing with external devices.

Additionally, data store 320, which can be any suitable combination of hardware and/or software, which provides for mass storage of information, databases, and programs employed in connection with aspects described herein. For example, data store 320 may be a data repository for applications not currently being executed by processor 305.

ELD 106 and/or communication device 146 may additionally include a user interface component 325 operable to receive inputs from a user, and further operable to generate outputs for presentation to the user. User interface component 325 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 325 may include one or more output devices, including but not limited to a display, a speaker, a haptic feedback mechanism, a printer, any other mechanism capable of presenting an output to a user, or any combination thereof.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the figures, which may illustrate various process flows.

As used in this description, the terms “component,” “database,” “component,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer.

Disk and disc, as used herein, includes compact disc (“CD”), laser disc, optical disc, digital versatile disc (“DVD”), floppy disk and blue-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of estimating driving costs, comprising:
receiving, at a communication device, a plurality of information corresponding to at least an operator and a vehicle of the operator;
executing, at the communication device, one or more analytics functions to determine a cost-per-mile (CPM) metric based at least on the plurality of information corresponding to at least the operator and the vehicle of the operator; and
providing a CPM report including the CPM metric to the operator based on executing the one or more analytics functions.

2. The method of claim 1, wherein the plurality of information includes at least one of fuel costs, miles driven by the vehicle, insurance costs of the vehicle, maintenance costs of vehicle, vehicle costs, brokerage fees, permits, toll fees, or workers compensation of the operator.

3. The method of claim 1, wherein the CPM metric corresponds to at least a CPM over a length of a route, a CPM over a length of time, and a CPM comparison between one or more operators.

4. The method of claim 1, wherein the CPM report comprises at least operator-related or vehicle related information including at least total miles driven by the operator over a time period, total miles driven by the operator compared to total miles driven by a plurality of operators, a miles per gallon (MPG) comparison with the plurality of operators, performance data analytics, and service recommendations.

5. The method of claim 1, wherein receiving the plurality of information further comprises receiving at least a portion of the plurality of information from a second device located within the vehicle, located with the operator, or located at a server across a communication network.

6. The method of claim 1, wherein executing the one or more analytics functions to determine the CPM metric further comprises executing the one or more analytics functions to determine the CPM metric periodically.

7. The method of claim 1, further comprising:
creating a user profile for the operator based on a plurality of user data, the user profile including at least a portion of the plurality of information;
receiving, at the communication device, a load indication, the load indication including information corresponding to a potential load for delivery to a client; and
wherein executing the one or more analytics functions to determine the CPM metric further comprises executing the one or more analytics functions based on the user profile and the information corresponding to the potential load to determine the CPM metric for the potential load in response to receiving the load indication.

8. The method of claim 7, wherein receiving the load indication further comprises receiving the load indication from a load board at a network operations system remote from the communication device, wherein the load board includes information corresponding to a plurality of potential loads for delivery for one or more clients.

9. The method of claim 7, further comprising:
executing, at the communication device, one or more additional analytics functions to determine an estimated profit margin for the potential load based at least on the CPM metric and the load indication; and
wherein the CPM report includes the estimated profit margin for the potential load.

10. The method of claim 9, wherein executing the one or more analytics functions to determine the CPM metric further comprises:
determining a route distance for delivering the potential load based at least on an initial starting location of the vehicle, or a pickup location of the potential load, and a delivery destination location;
determining an average fuel cost between the initial starting location, or the pickup location, and the destination location;
calculating a load specific CPM metric based at least on the plurality of information and the average fuel cost; and
calculating a total route cost for the potential delivery route based at least on the route distance and the load specific CPM metric.

11. The method of claim 10, wherein the load indication includes a price quote for the potential load; and
wherein executing the one or more additional analytics functions to determine the estimated profit margin for the potential load further comprises:
calculating the estimated profit margin for the potential delivery load based at least on load specific CPM metric and the price quote.

12. An apparatus for estimating driving costs, comprising:
a processor;
a memory coupled to the processor, wherein the memory includes instructions executable by the processor to:
receive, at a communication device, a plurality of information corresponding to at least an operator and a vehicle of the operator;
execute, at the communication device, one or more analytics functions to determine a cost-per-mile (CPM) metric based at least on the plurality of information corresponding to at least the operator and the vehicle of the operator; and
provide a CPM report including the CPM metric to the operator based on executing the one or more analytics functions.

13. The apparatus of claim 12, wherein the plurality of information includes at least one of fuel costs, miles driven by the vehicle, insurance costs of the vehicle, maintenance costs of vehicle, vehicle costs, brokerage fees, permits, toll fees, or workers compensation of the operator.

14. The apparatus of claim 12, wherein the CPM metric corresponds to at least a CPM over a length of a route, a CPM over a length of time, and a CPM comparison between one or more operators.

15. The apparatus of claim 12, wherein the CPM report comprises at least operator-related or vehicle related information including at least total miles driven by the operator over a time period, total miles driven by the operator compared to total miles driven by a plurality of operators, a miles per gallon (MPG) comparison with the plurality of operators, performance data analytics, and service recommendations.

16. The apparatus of claim 12, wherein the processor is further configured to:
create a user profile for the operator based on a plurality of user data, the user profile including at least a portion of the plurality of information;
receive, at the communication device, a load indication, the load indication including information corresponding to a potential load for delivery to a client; and
execute the one or more analytics functions based on the user profile and the information corresponding to the potential load to determine the CPM metric for the potential load in response to receiving the load indication.

17. The apparatus of claim 16, wherein the processor configured to receive the load indication is further configured to receive the load indication from a load board at a network operations system remote from the communication device, wherein the load board includes information corresponding to a plurality of potential loads for delivery for one or more clients.

18. The apparatus of claim 16, wherein the processor is further configured to:
execute, at the communication device, one or more additional analytics functions to determine an estimated profit margin for the potential load based at least on the CPM metric and the load indication; and
wherein the CPM report includes the estimated profit margin for the potential load.

19. The apparatus of claim 16, wherein the processor configured to execute the one or more analytics functions to determine the CPM metric is further configured:
determine a route distance for delivering the potential load based at least on an initial starting location of the vehicle, or a pickup location of the potential load, and a delivery destination location;
determine an average fuel cost between the initial starting location, or the pickup location, and the destination location;
calculate a load specific CPM metric based at least on the plurality of information and the average fuel cost; and
calculate a total route cost for the potential delivery route based at least on the route distance and the load specific CPM metric.

20. A non-transitory computer readable medium for estimating driving costs, wherein the computer readable medium comprises:
code executable by a processor to receive, at a communication device, a plurality of information corresponding to at least an operator and a vehicle of the operator;
code executable by a processor to execute, at the communication device, one or more analytics functions to determine a cost-per-mile (CPM) metric based at least on the plurality of information corresponding to at least the operator and the vehicle of the operator; and
code executable by a processor to provide a CPM report including the CPM metric to the operator based on executing the one or more analytics functions.
